(19) United States
(12) Patent Application Publication
(10) Pub. No.: US 2026/0056822 A1
(43) Pub. Date: Feb. 26, 2026

(54) METHODS AND SYSTEMS FOR MANAGING HOST CRITICAL FAILURE EVENTS

(71) Applicant: SAMSUNG ELECTRONICS CO., LTD., Suwon-si (KR)

(72) Inventors: Ganesh Babu VASUDEVAN, Bengaluru (IN); Pradeep Sagar Ramachadra, Bengaluru (IN); Puneet Kukreja, Bengaluru (IN); Akhilesh Kumar Jaiswal, Bengaluru (IN)

(73) Assignee: SAMSUNG ELECTRONICS CO., LTD., Suwon-si (KR)

(21) Appl. No.: 18/970,212

(22) Filed: Dec. 5, 2024

(30) Foreign Application Priority Data
Aug. 21, 2024 (IN) 202441063219

(51) Int. Cl. G06F 11/07

(52) U.S. Cl. CPC G06F 11/0772; G06F 11/0778; G06F 11/079

(57) ABSTRACT

A method for managing a failure condition at a host includes detecting an occurrence of a host critical failure event at the host, configuring at least one panic bit of a host panic control register of a device, based on the detecting of the occurrence of the host critical failure event, and issuing, to the device, at least one input/output (I/O) read/write command.

### CROSS-REFERENCE TO RELATED APPLICATIONS

This application claims benefit of priority under 35 U.S. C. § 119 to Indian Patent Application No. 202441063219, filed on Aug. 21, 2024, in the Indian Patent Office, the disclosure of which is incorporated by reference herein in its entirety.

### BACKGROUND

### 1. Field

The present disclosure relates generally computing systems, and more particularly, to identification and management of host critical failure events.

### 2. Description of Related Art

A blue screen of death (BSOD) or stop error may refer to an error screen that may be displayed when an operating system of a computing system encounters a fatal system error and crashes, or the like. Such a system error may occur with no warning and may result in all unsaved work being immediately lost. The BSOD may be triggered by software problems (e.g., incompatible driver updates, a virus, or the like) and/or by hardware problems (e.g., a hard drive that needs formatting, overheating that may be caused by overclocking a central processing unit (CPU)).

Alternatively or additionally, the BSOD may be a result of hardware communication problems and/or corrupted files. However, a precise cause may be diagnosed via a provided error code. While a BSOD or such fatal host system error may be triggered in an operating system (and/or host) for various reasons, the same failure information may not be communicated to a flash device.

For example, during a host failure event, the operating system may obtain information that may be needed to diagnose and/or correct the failure (e.g., a host dump), may save the information, and may subsequently reset the system and/or device. That is, the device (e.g., a flash device, a dynamic random access memory (DRAM), a static random access memory (SRAM)) may remain active and may receive the read/write commands that may be needed to perform the host dump collection process without being provided with an indication of the host failure event. Consequently, when the operating system resets and in turn resets the device that is used to store the host dump, device context information of the device at the time of the failure event may be lost due to the device reset.

As a result, it may be difficult to perform failure analysis of host failure events on such systems and/or devices. In addition, such systems and/or devices may not provide for a mechanism to trigger a firmware level dump at the time of BSOD or any such host failure event. For at least these reasons, failure events that may occur at different customer sites on multiple host environments may require extensive reproduction of failure analysis by suppliers, thereby leading to a relatively large turnaround time for support, which may negatively impact a Quality of Service (QOS) and/or support cost to original equipment manufacturers (OEMs) and/or device vendors.

Thus, there exists a need to provide a method and a system that overcomes the stated problems by providing identification and management of host critical failure events such that the device context information is not lost.

The information disclosed in this background of the disclosure section is only for enhancement of understanding of the general background of the disclosure and may not be taken as an acknowledgement or any form of suggestion that this information forms the related art that may be known to a person skilled in the art.

### SUMMARY

The foregoing summary is illustrative only and is not intended to be in any way limiting. In addition to the illustrative aspects, embodiments, and features described above, further aspects, embodiments, and features may become apparent by reference to the drawings and the following detailed description.

According to an aspect of the present disclosure, a method for managing a failure condition at a host includes detecting an occurrence of a host critical failure event at the host, configuring at least one panic bit of a host panic control register of a device, based on the detecting of the occurrence of the host critical failure event, and issuing, to the device, at least one input/output (I/O) read/write command.

According to an aspect of the present disclosure, a method for managing a device internal context during a host failure condition at a device includes detecting a host critical failure event by monitoring status of a host panic control register, receiving, from a host, at least one I/O read/write command, and storing, in a memory, device context information based on the at least one I/O read/write command.

According to an aspect of the present disclosure, a method for managing a failure condition at a host includes detecting, in a device, a presence of a host panic capability register exhibiting support for host panic situation awareness, preconfiguring a host panic control register of the device, and based on an occurrence of the host critical failure event, issuing, to the device, at least one I/O read/write command. The preconfiguring includes writing, in the host panic control register, a host panic table including addresses and corresponding data/value pairs. Each entry of the host panic table indicates a host critical failure event.

According to an aspect of the present disclosure, a method for managing a device internal context during a host failure condition at a device includes defining a custom host panic capability register exhibiting support for host panic situation awareness, monitoring occurrences of writes to memory addresses that are mapped to the host panic table, receiving, from the host, at least one I/O read/write command, and storing, in a memory, device context information based on the at least one I/O read/write command. A host panic control register includes a host panic table and a table size of the host panic table. The host panic table having been initialized by a host during runtime.

According to an aspect of the present disclosure, a system for managing a failure condition at a host includes a memory storing instructions, and at least one processor in communication with the memory. The at least one processor is configured to execute the instructions to detect an occurrence of a host critical failure event at the host, configure at least one panic bit of a host panic control register of a device, based on detection of the occurrence of the host critical failure event, and issue, to the device, at least one I/O read/write command.

According to an aspect of the present disclosure, a system for managing a device internal context during a host failure condition at a device includes a memory storing instructions, and at least one processor in communication with the memory. The at least one processor is configured to execute the instructions to detect a host critical failure event by monitoring status of a host panic control register, receive, from a host, at least one I/O read/write command, and store, in the memory, device context information based on the at least one I/O read/write command.

According to an aspect of the present disclosure, a system for managing a failure condition at a host, the system includes a memory storing instructions, and at least one processor in communication with the memory. The at least one processor is configured to execute the instructions to detect, in a device, a presence of a host panic capability register exhibiting support for host panic situation awareness, preconfigure a host panic control register of the device, wherein to preconfigure the host panic control register includes to write, in the host panic control register, and based on an occurrence of the host critical failure event, issue, to the device, at least one I/O read/write command. A host panic table includes addresses and corresponding data/value pairs. Each entry of the host panic table indicates a host critical failure event.

According to an aspect of the present disclosure, a system for managing a device internal context during a host failure condition at a device includes a memory storing instructions, and at least one processor in communication with the memory. The at least one processor is configured to execute the instructions to define a custom host panic capability register exhibiting support for host panic situation awareness, monitor occurrences of writes to memory addresses that are mapped to the host panic table, receive, from the host, at least one I/O read/write command, and store, in the memory, device context information based on the at least one I/O read/write command. A host panic control register includes a host panic table and a table size of the host panic table. The host panic table having been initialized by a host during runtime.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 illustrates an environment showing interaction of a host with a peripheral component interconnect express (PCIe) device, according to an embodiment;

FIG. 2A illustrates a data flow/signaling diagram for managing a device internal context during a host failure condition at a device, according to an embodiment;

FIG. 2B illustrates another data flow/signaling diagram for managing a device internal context during a host failure condition at a device, according to an embodiment;

FIG. 3A illustrates a block diagram of a system for managing a failure condition at a host, according to an embodiment;

FIG. 3B illustrates a block diagram of a system for managing a device internal context during a host failure condition at a device, according to an embodiment;

FIG. 4A illustrates a flowchart of a method for managing a failure condition at a host, according to an embodiment;

FIG. 4B illustrates a flowchart of a method for managing a device internal context during a host failure condition at a device, according to an embodiment;

FIG. 5A illustrates a flowchart of a method for managing a failure condition at a host, according to an embodiment; and

FIG. 5B illustrates a flowchart of a method for managing a device internal context during a host failure condition at a device, according to an embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

As used herein, the term “exemplary” may refer to “serving as an example, instance, or illustration”. Any embodiment or implementation of the present disclosure described herein as “exemplary” may not necessarily to be construed as preferred or advantageous over other embodiments.

While the present disclosure is susceptible to various modifications and alternative forms, embodiments thereof are shown by way of example in the drawings and are described in detail below. It may be understood, however, the described embodiments are not intended to limit the present disclosure to the particular forms disclosed, but on the contrary, the present disclosure is to cover a plurality of modifications, equivalents, and alternatives falling within the spirit and the scope of the present disclosure.

The terms “comprises”, “comprising”, or any other variations thereof, are intended to cover a non-exclusive inclusion, such that a setup, device, or method that comprises a list of components, operations, or steps does not include only those components or operations but may include other components or operations not expressly listed or inherent to such setup or device or method. That is, one or more elements in a device or system or apparatus proceeded by “comprises . . . a” does not, without more constraints, preclude the existence of other elements or additional elements in the device or system or apparatus.

In the following detailed description of the embodiments of the present disclosure, reference is made to the accompanying drawings that form a part hereof, and in which are shown by way of illustration specific embodiments in which the present disclosure may be practiced. These embodiments are described in sufficient detail to enable those skilled in the art to practice the present disclosure, and it is to be understood that other embodiments may be utilized and that changes may be made without departing from the scope of the present disclosure. The following description is, therefore, not to be taken in a limiting sense.

The terminology “peripheral component interconnect (PCI) express (PCIe) device”and “device”may be interchangeably used throughout the present disclosure.

The terminology “host”, “operating system (OS)” and “host OS” may be interchangeably used throughout the present disclosure.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

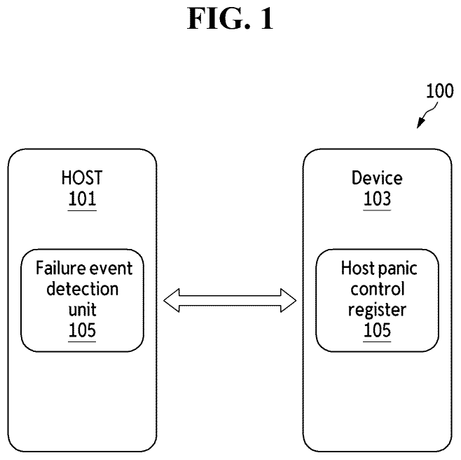

FIG. 1 illustrates an environment 100 showing interaction of host with a PCIe device, according to an embodiment. The environment 100 depicts the host 101 and the device 103 in communication with each other. The host 101 may be initially loaded into the device 103 by a boot program and the host 101 may be responsible for managing all of the other application programs in the device 103.

The host 101 may witness (e.g., detect) a critical failure event during the operation of the host 101. The critical failure event may include, but not be limited to, an improper driver event, a thrashing event, a corrupt registry event, a virus event, a Trojan Horse event, a slow system performance event, a failure to boot event, a compatibility error event, a power problem event, an overheating event, a motherboard failure event, a faulty random access memory (RAM) event, a faulty storage event, a faulty processor event, or the like.

In an embodiment, the host 101 may include a failure event detection unit 105 for detecting an occurrence of a host critical failure event in the host 101. The device 103 may comprise a host panic control register 107 for exhibiting (e.g., indicating) support for host panic situation awareness in the device 103.

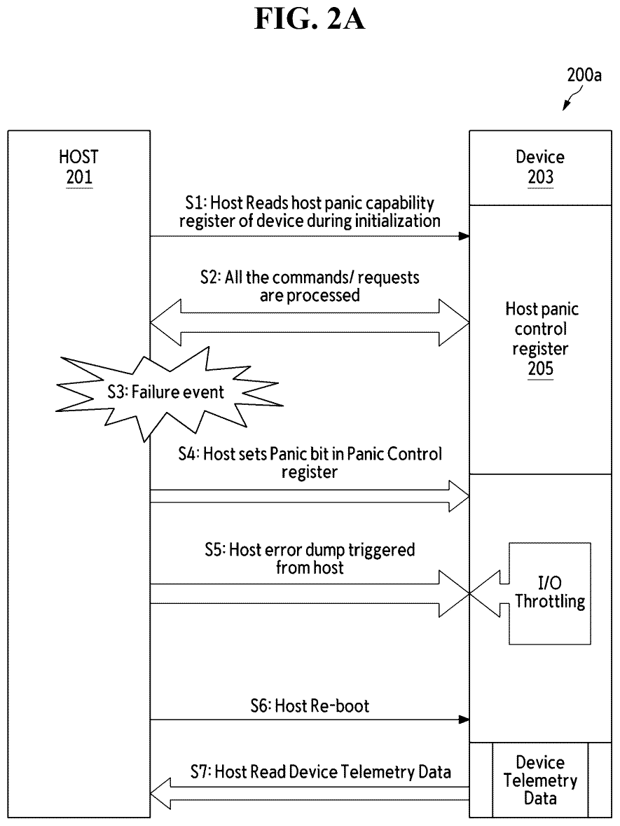

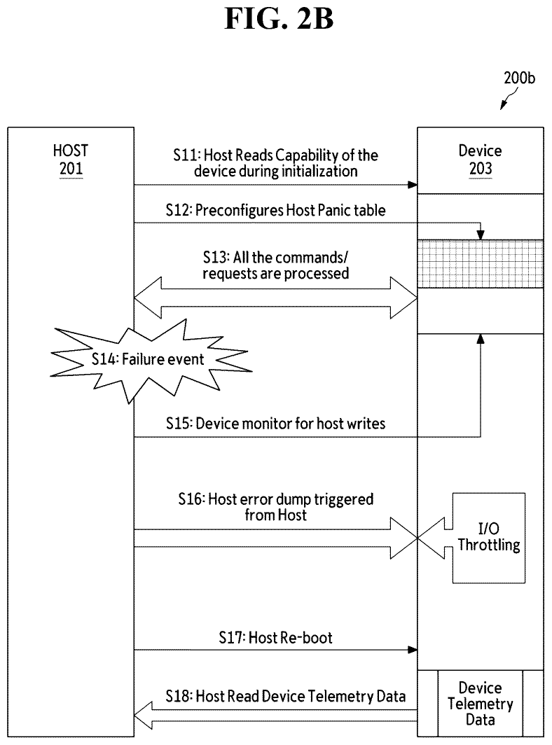

In an embodiment, the host 101 may manage a host critical failure event based on the host panic capability indicated by the device 103 by using the host panic control register 107, which is discussed in below embodiments by taking reference of FIGS. 2A and 2B.

FIG. 2A illustrates a data flow/signaling diagram for managing a device internal context during a host failure condition at a device, according to an embodiment.

The host 201 of FIGS. 2A and 2B may include and/or may be similar in many respects to the host 101 described above with reference to FIG. 1, and may include additional features not mentioned above. Furthermore, the device 203 of FIGS. 2A and 2B may include and/or may be similar in many respects to the device 103 described above with reference to FIG. 1, and may include additional features not mentioned above. Consequently, repeated descriptions of the host 201 and the device 203 described above with reference to FIG. 1 may be omitted for the sake of brevity.

The host 201 may read the host panic capability register of the device 203 during the initialization of the device 203 (operation S1). The device 203 may define the host panic control register 205 that exhibits (e.g., indicates) that the device 203 supports host panic situation awareness.

After initialization, the host 201 and the device 203 may process all the commands/requests (operation S2). The commands/requests may correspond to respective tasks/operations of the host 201 and the device 203.

In operation S3, an occurrence of a host critical failure event may be detected at the host 201. The host critical failure event may comprise one or more of, but not be limited to, an improper driver event, a thrashing event, a corrupt registry event, a virus event, a Trojan Horse event, a slow system performance event, a failure to boot event, a compatibility error event, a power problem event, an overheating event, a motherboard failure event, a faulty RAM event, a faulty storage event, a faulty processor event, or the like.

In response to detection of the host critical failure event, the host 201 may set at least one panic bit present in the host panic control register 205 of the device 203 (operation S4).

The device 203 may initiate an input/output (I/O) throttling mechanism for the host error dump triggered from the host 201 (operation S5). During the host error dump, the host 201 may issue one or more I/O read/write commands for the device 203 and the device context information may be saved in the form of device telemetry data based on the I/O read/write commands issued by the host 201. Once the device context information is saved, the device 203 may stop the I/O throttling mechanism and may allow the I/O read/write commands from the host 201.

The host 201 may complete the host error dump by writing on to the device 203, and the host 201 may reboot the device 203 (operation S6). The host 201 may fetch device telemetry data comprising the device context information after the reboot for failure analysis (operation S7).

For example, the host 201 may read device telemetry data from a log page stored in the device 203. The host 201 may further determine device context information at the time of the host critical failure event.

Thus, the host panic control register 205 may facilitate indication of the host critical failure event to the device 203, thereby allowing the device 203 to save the device context information. The device context information may be accessed by the host 201 post fatal condition occurrences and may be provided for post processing and/or interpretation to a device vendor. Consequently, ease of remote support to the end user of the device 203 and/or Quality of Service (QOS) may be improved. In addition, device context availability may result in cost savings at original equipment manufacturers (OEMs) and/or device vendors.

FIG. 2B illustrates another data flow/signaling diagram for managing a device internal context during a host failure condition at a device, according to an embodiment.

The host 201 may read the host panic capability register of the device 203 during the initialization of the device 203 (operation S11). The device 203 may define the host panic control register 205 that exhibits (e.g., indicates) that the device 203 supports host panic situation awareness and/or that the device 203 has a host panic capability.

After initialization, the host 201 may preconfigure a host panic control register 205 of the device 203. The pre-configuration may include writing a host panic table in the host panic control register 205 with specific addresses and corresponding data/value pairs. Each entry of the host panic table may indicate a host critical failure event that may occur at a later stage (operation S12).

After pre-configuration, the host 201 and the device 203 may process all the commands/requests (operation S13). The commands/requests may correspond to respective tasks/operations of the host 201 and the device 203.

In operation S14, an occurrence of a host critical failure event may be detected at the host 201. The host critical failure event may include one or more of, but not be limited to, an improper driver event, a thrashing event, a corrupt registry event, a virus event, a Trojan Horse event, a slow system performance event, a failure to boot event, a compatibility error event, a power problem event, an overheating event, a motherboard failure event, a faulty RAM event, a faulty storage event, a faulty processor event, or the like.

The device 203 may monitor any occurrence of writes that are mapped to the host panic table preconfigured by the host 201 (operation S15).

The device 203 may initiate an I/O throttling mechanism for the host error dump triggered from the host 201 (operation S16). During the host error dump, the host 201 may issue one or more I/O read/write commands for the device 203 and the device context information may be saved in the form of device telemetry data based on the I/O read/write commands issued by the host 201. Once the device context information is saved, the device 203 may stop the I/O throttling mechanism and may allow the I/O read/write commands from the host 201.

The host 201 may complete the host error dump by writing on to the device 203, and the host may reboot the device 203 (operation S17). The host 201 may fetch device telemetry data comprising the device context information after the reboot for failure analysis (operation S18).

For example, the host 201 may read the device telemetry data from a log page stored in the device 203. The host 201 may further determine device context information at the time of the host critical failure event.

The preconfigured host panic table in the host panic control register 205 may facilitate indication of host critical failure event to the device 203, thereby allowing the device 203 to save the device context information. The device context information may be accessed by the host 201 post fatal condition occurrences and may be provided for post processing and/or interpretation to a device vendor. Consequently, ease of remote support to the end user of the device 203 and/or QoS may be improved. In addition, device context availability may result in cost savings at OEMs and/or device vendors.

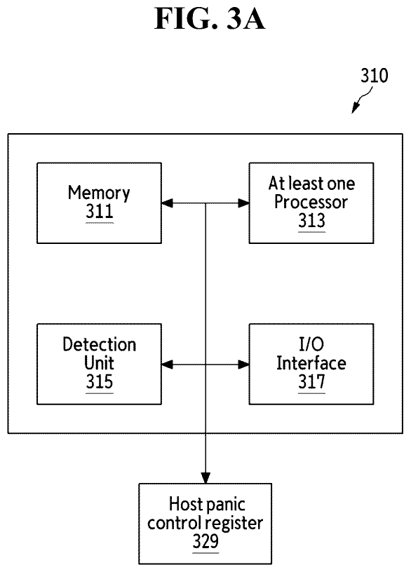

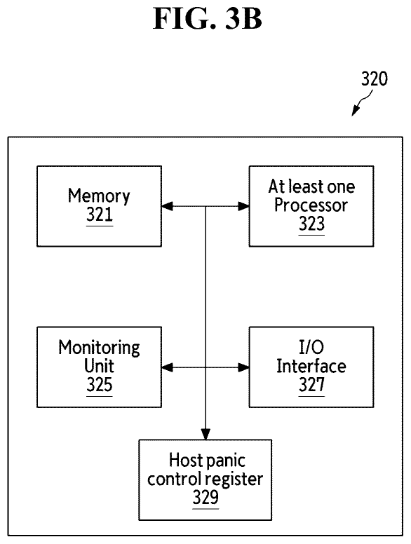

FIG. 3A illustrates a block diagram of a system 310 for managing a failure condition at a host, according to an embodiment.

Referring to FIG. 3A, the system 310 may comprise a memory 311, at least one processor 313, a detection unit 315, and an I/O interface 317 communicatively coupled with each other. In a non-limiting embodiment, the system 310 may be coupled to the system 320 of FIG. 3B using a communication interface. In another non-limiting embodiment, the system 310 may be installed on to the system 320 of FIG. 3B.

The system 310 may include and/or may be similar in many respects to the hosts 101 and 201 described above with reference to FIGS. 1, 2A, and 2B, and may include additional features not mentioned above. Consequently, repeated descriptions of the system 310 described above with reference to FIGS. 1, 2A, and 2B may be omitted for the sake of brevity.

It may be noted that, in some embodiments, the system 310 may include more or fewer components than those depicted herein. The various components of the system 310 may be implemented using hardware, software, firmware, and/or any combinations thereof. Further, the various components of the system 310 may be operably coupled with each other. That is, various components of the system 310 may be capable of communicating with each other using communication channel media (e.g., buses, interconnects, and the like).

In an embodiment, the at least one processor 313 may be embodied as a multi-core processor, a single core processor, or a combination of one or more multi-core processors and/or one or more single core processors. For example, the at least one processor 313 may be embodied as one or more of various processing devices, such as, but not limited to, a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

In an embodiment, the memory 311 may be configured to store machine executable instructions, which may be referred to herein as instructions. In an embodiment, the at least one processor 313 may be embodied as an executor of software instructions. As such, the at least one processor 313 may be capable of executing the instructions stored in the memory 311 to perform one or more operations described herein.

The memory 311 may be any type of storage accessible to the at least one processor 313 to perform respective functionalities. For example, the memory 311 may include one or more volatile and/or non-volatile memories, or a combination thereof. For example, the memory 311 may be embodied as semiconductor memories, such as, but not limited to, flash memory, mask read-only memory (ROM), programmable ROM (PROM), erasable PROM (EPROM), RAM, or the like.

In an embodiment, the at least one processor 313 may be configured to determine a presence of host panic capability register during an initialization of a device 203. The presence of the host panic capability register may indicate/suggest to the host 201 that the device 203 supports host panic situation awareness and the presence may be detected during the initialization of the device 203.

The at least one processor 313 may be further configured to detect an occurrence of a host critical failure event in the host 201. The host critical failure event may be detected by the detection unit 315 that may continuously (e.g., periodically, aperiodically, on demand, or the like) inspect the host condition.

The host critical failure event may include, but not be limited to, an improper driver event, a thrashing event, a corrupt registry event, a virus event, a Trojan Horse event, a slow system performance event, a failure to boot event, a compatibility error event, a power problem event, an overheating event, a motherboard failure event, a faulty RAM event, a faulty storage event, a faulty processor event, or the like. In a non-limiting embodiment, the host critical failure event may lead to a blue screen of death (BSOD).

The at least one processor 313 may configure at least one panic bit on a host panic control register 329 of a device 203, in response to the occurrence of the host critical failure event. That is, the at least one processor 313 may be configured to write at least one bit on the host panic control register 329 of the device 203. The at least one panic bit may indicate the type of host critical failure event to the device 203. The at least one panic bit may be used to inform the device 203 to initiate a backup of device internal context information.

The at least one processor 313 may be configured to issue at least one I/O read/write command to the device 203. The I/O read/write command may be issued by the host 201 for the host dump operation. In a non-limiting embodiment, the I/O read/write command may vary based on the device internal context and the host dump operation.

Alternatively or additionally, the at least one processor 313 may be configured to detect a presence of host panic capability register exhibiting support for host panic situation awareness in a device 203. The presence of the host panic capability register may be determined during the initialization of the device 203.

The at least one processor 313 may be further configured to preconfigure a host panic control register 329 of the device 203. The pre-configuration may include writing a host panic table in the host panic control register 329 with specific addresses and corresponding data/value pairs. Each entry of the host panic table may indicate a host critical failure event that may occur at a later stage and a type of write operation to be performed by the host, when the corresponding host critical failure event occurs.

The at least one processor 313 may be configured to detect an occurrence of a host critical failure event in the host 201. The host critical failure event may be detected by the detection unit 315 that may continuously (e.g., periodically, aperiodically, on demand, or the like) inspect the host condition.

In response to the detection of the occurrence of the host critical failure event, the at least one processor 313 may be configured to issue at least one I/O read/write command to the device 203. For example, the I/O write/read command may be issued by the host 201 for the host dump operation. In a non-limiting embodiment, the I/O write/read command may vary based on the device internal context and the host dump operation.

In a non-limiting embodiment, the issued I/O read/write commands may timeout after a predetermined time period has elapsed (e.g., eight (8) seconds) and another I/O read/write command may be issued for completing the host dump operation. However, the timeout of I/O read/write command is not limited to above example, and other timeout values (e.g., less than eight (8) seconds, or greater than eight (8) seconds) may be within the scope of the present disclosure.

FIG. 3B illustrates a block diagram of a system for managing a device internal context during a host failure condition at a device, according to an embodiment.

The system 320 may include and/or may be similar in many respects to the devices 103 and 203 described above with reference to FIGS. 1, 2A, and 2B, and may include additional features not mentioned above. Consequently, repeated descriptions of the system 320 described above with reference to FIGS. 1, 2A, and 2B may be omitted for the sake of brevity.

In an embodiment, the system 320 may comprise a memory 321, at least one processor 323, a monitoring unit 325, an I/O interface 327, and a host panic control register 329 communicatively coupled with each other. In a non-limiting embodiment, the system 320 may be coupled to the system 310 of FIG. 3A using a communication interface. In another non-limiting embodiment, the system 310 of FIG. 3A may be installed on to the system 320 of FIG. 3B.

It may be noted that, in some embodiments, the system 320 may include more or fewer components than those depicted herein. The various components of the system 320 may be implemented using hardware, software, firmware, and/or any combinations thereof. Further, the various components of the system 320 may be operably coupled with each other. For example, various components of the system 320 may be capable of communicating with each other using communication channel media (e.g., buses, interconnects, or the like).

In an embodiment, the at least one processor 323 may be embodied as a multi-core processor, a single core processor, or a combination of one or more multi-core processors and/or one or more single core processors. For example, the at least one processor 323 may be embodied as one or more of various processing devices, such as, but not limited to, a coprocessor, a microprocessor, a controller, a DSP, a processing circuitry with or without an accompanying DSP, or various other processing devices including, an MCU, a hardware accelerator, a special-purpose computer chip, or the like.

In an embodiment, the memory 321 may be configured to store machine executable instructions, which may be referred to herein as instructions. In an embodiment, the at least one processor 323 may be embodied as an executor of software instructions. As such, the at least one processor 323 may be capable of executing the instructions stored in the memory 321 to perform one or more operations described herein.

The memory 321 may be any type of storage accessible to the at least one processor 323 to perform respective functionalities. For example, the memory 321 may include one or more volatile and/or non-volatile memories, or a combination thereof. For example, the memory 321 may be embodied as semiconductor memories, such as, but not limited to, flash memory, mask ROM, PROM, EPROM, RAM, or the like.

In an embodiment, the at least one processor 323 may be configured to initialize a host panic capability register during an initialization of the device 203 to indicate that the device 203 supports host panic situation awareness. The at least one processor 323 may receive information regarding occurrence of host critical failure event through the host panic control register 329.

The at least one processor 323 may be configured to monitor status of a host panic control register 329 for detection of a host critical failure event. The monitoring may include reading of the bits present in the host panic control register 329 using the monitoring unit 325.

The at least one processor 323 may be further configured to receive at least one I/O read/write command issued from a host 201. The at least one processor 323 may be configured to initiate an I/O throttling mechanism and start store device context information in the memory 321.

In a non-limiting embodiment, the at least one processor 323 may turn off the I/O throttling mechanism once the device context information is stored in the memory 321. The turning off of the I/O throttling mechanism may allow the host 201 to perform the host dump operation.

Thus, the host panic control register 329 may facilitate indication of a host critical failure event to the device 203, thereby allowing the device 203 to save the device context information. The device context information may be accessed by the host 201 post fatal condition occurrences and may be provided for post processing and/or interpretation to a device vendor. Consequently, ease of remote support to the end user of the device 203 and/or QoS may be improved. In addition, device context availability may result in cost savings at OEMs and/or device vendors.

Alternatively or additionally, the at least one processor 323 may be configured to define a custom host panic capability register exhibiting support for host panic situation awareness. The host panic control register 329 may include a host panic table and a table size of the host panic table. The host may preconfigure the table by writing a host panic table in the host panic control register 329 with specific addresses and corresponding data/value pairs. Each entry of the host panic table may indicate a host critical failure event that may occur at a later stage and a type of write operation to be performed by the host 201, when the corresponding host critical failure event occurs.

The at least one processor 323 may be further configured to monitor occurrences of writes that are mapped to the host panic table initialized by the host 201 during runtime. The monitoring may be performed using the monitoring unit 325.

The at least one processor 323 may be further configured to receive at least one I/O read/write command issued from the host 201. The at least one processor 323 may be configured to initiate an I/O throttling mechanism and start storing device context information in the memory 321.

In a non-limiting embodiment, the at least one processor 323 may turn off the I/O throttling mechanism once the device context information is stored in the memory 321. The turning off of the I/O throttling mechanism may allow the host 201 to perform the host dump operation.

Thus, the preconfigured host panic table in the host panic control register 329 facilitates indication of a host critical failure event to the device 203, thereby allowing the device 203 to save the device context information. The device context information may be accessed by the host 201 post fatal condition occurrences and may be provided for post processing and/or interpretation to a device vendor. Consequently, ease of remote support to the end user of the device 203 and/or better QoS may be improved. In addition, device context availability may result in cost savings at OEMs and/or device vendors.

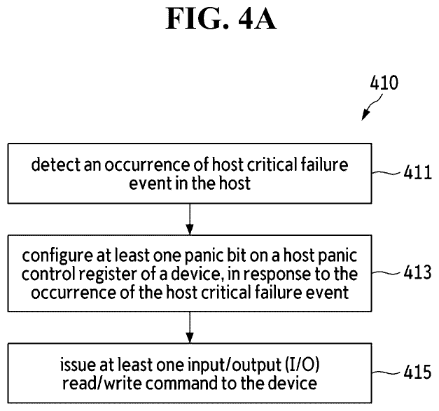

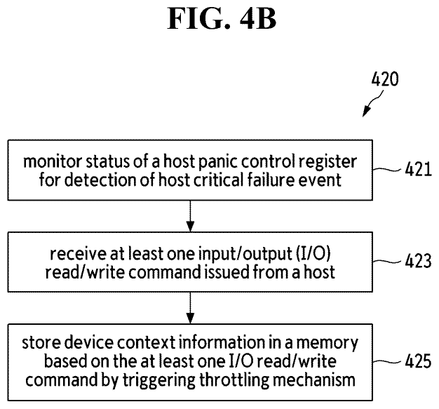

FIG. 4A illustrates a flowchart of a method 410 for managing a failure condition at a host, according to an embodiment.

The operations of the method 410 may be described and/or practiced by using at least one processor 313 of the system 310 and/or the hosts 101 and 201 as described with reference to FIGS. 1 to 3B.

At operation 411, the method 410 may include detecting an occurrence of a host critical failure event in the host 201. The host critical failure event may be detected by continuous (e.g., periodic, aperiodic, on demand, or the like) inspection of the host condition. The host critical failure event may include, but not be limited to, an improper driver event, a thrashing event, a corrupt registry event, a virus event, a Trojan Horse event, a slow system performance event, a failure to boot event, a compatibility error event, a power problem event, an overheating event, a motherboard failure event, a faulty RAM event, a faulty storage event, a faulty processor event, or the like. In a non-limiting embodiment, the host critical failure event may result in a BSOD.

In an embodiment, the method 410 may include determining a presence of host panic capability register during an initialization of a device 203. The presence of host panic capability register may indicate/suggest to the host 201 that the device 203 supports host panic situation awareness and the presence may be detected during the initialization of the device 203.

At operation 413, the method 410 may include configuring at least one panic bit on a host panic control register 329 of the device 203, in response to the occurrence of the host critical failure event. The method 410 may further include writing at least one bit on the host panic control register 329 of the device 203. The at least one panic bit may indicate the type of host critical failure event to the device 203. The at least one panic bit may be used to inform the device 203 to initiate the backup of the device internal context information.

At operation 415, the method 410 may include issuing at least one I/O read/write command to the device 203. The I/O read/write command may be issued by the host 201 for the host dump operation. In a non-limiting embodiment, the I/O read/write command may vary based on the device internal context and the host dump operation.

In a non-limiting embodiment, the issued I/O read/write commands may timeout after a predetermined time period has elapsed (e.g., eight (8) seconds) and another I/O read/write command may be issued for completing the host dump operation. However, the timeout of I/O read/write command is not limited to the above example, and other timeout values (e.g., less than eight (8) seconds, or greater than eight (8) seconds) may be within the scope of the present disclosure.

FIG. 4B illustrates a flowchart of a method 420 for managing a device internal context during a host failure condition at a device, according to an embodiment.

The operations of the method 420 may be described and/or practiced by using at least one processor 323 of the system 320 and/or the devices 103 and 203 as described with reference to FIGS. 1 to 3B.

At operation 421, the method 420 may include monitoring status of a host panic control register 329 for detection of a host critical failure event. The monitoring may include reading of the bits present in the host panic control register 329.

In an embodiment, the method 420 may further include initializing a host panic capability register during an initialization of the device 203 to indicate that the device 203 supports host panic situation awareness and receiving information regarding occurrence of a host critical failure event through the host panic control register 329.

At operation 423, the method 420 may include receiving at least one I/O read/write command issued from a host 201. The method 420 may further include initiating an I/O throttling mechanism for storing the device context information of the device 203.

At operation 425, the method 420 may include storing device context information in the memory 321 based on the I/O read/write commands issued by the host 201. The method 420 may further include turning off the I/O throttling mechanism once the device context information is stored in the memory 321. The turning off of the I/O throttling mechanism may allow the host 201 to perform the host dump operation.

Thus, the host panic control register 329 may facilitate indication of a host critical failure event to the device 203, thereby allowing the device 203 to save the device context information. The device context information may be accessed by the host 201 post fatal condition occurrences and may be provided for post processing and/or interpretation to a device vendor. Consequently, ease of remote support to the end user of the device and/or QoS may be improved. In addition, device context availability may result in cost savings at OEMs and/or device vendors.

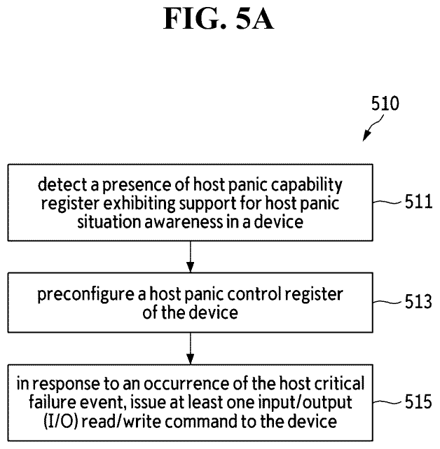

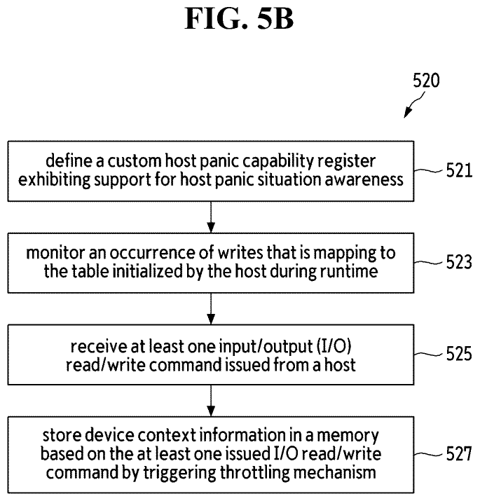

FIG. 5A illustrates a flowchart of a method 510 for managing a failure condition at a host, according to an embodiment.

The operations of the method 510 may be described and/or practiced by using at least one processor 313 of the system 310 and/or the hosts 101 and 201 as described with reference to FIGS. 1 to 4B.

At operation 511, the method 510 may include detecting a presence of a host panic capability register exhibiting support for host panic situation awareness in a device 203. The presence of host panic capability register may be determined during the initialization of the device 203.

At operation 513, the method 510 may include preconfiguring a host panic control register 329 of the device 203. The pre-configuring may include writing a host panic table in the host panic control register 329 with specific addresses and corresponding data/value pairs. Each entry of the host panic table may indicate a host critical failure event that may occur at a later stage and a type of write operation to be performed by the host 201 when the corresponding host critical failure event occurs.

At operation 515, the method 510 may include detecting an occurrence of host critical failure event in the host 201. The host critical failure event may be detected by continuous (e.g., periodic, aperiodic, on demand, or the like) inspection of the host condition. In response to occurrence of the host critical failure event, the method 510 may include issuing at least one I/O read/write command to the device 203. The I/O read/write command may be issued by the host 201 for the host dump operation. In a non-limiting embodiment, the I/O read/write command may vary based on the device internal context and the host dump operation.

In a non-limiting embodiment, the issued I/O read/write commands may timeout after a predetermined time period has elapsed (e.g., eight (8) seconds) and another I/O read/write command may be issued for completing the host dump operation. However, the timeout of the I/O write/read command is not limited to the above example, and other timeout values (e.g., less than eight (8) seconds, or greater than eight (8) seconds) may be within the scope of the present disclosure.

FIG. 5B illustrates a flowchart of a method 520 for managing a device internal context during a host failure condition at a device, according to an example.

The operations of the method 520 may be described and/or practiced by using at least one processor 323 of the system 320 and/or the devices 103 and 203 as described with reference to FIGS. 1 to 4B.

At operation 521, the method 520 may include defining a custom host panic capability register exhibiting support for host panic situation awareness. The host panic control register 329 may include a host panic table and a table size of the host panic table. The host 201 may preconfigure the host panic table by writing a host panic table in the host panic control register 329 with specific addresses and corresponding data/value pairs. Each entry of the host panic table may indicate a host critical failure event that may occur at a later stage and a type of write operation to be performed by the host 201 when the corresponding host critical failure event occurs.

At operation 523, the method 520 may include monitoring occurrences of writes that are mapped to the host panic table initialized by the host 201 during runtime. At operation 525, the method 520 may include receiving at least one I/O read/write command issued from the host 201. The method 520 may further include initiating/triggering an I/O throttling mechanism. At operation 527, the method 520 may include storing device context information in the memory 321 based on the at least one of the issued I/O read/write commands.

The method 520 may further include turning off the I/O throttling mechanism once the device context information is stored in the memory 321. The turning off of the I/O throttling mechanism may allow the host 201 to perform the host dump operation.

Thus, the preconfigured host panic table in the host panic control register 329 may facilitate indication of a host critical failure event to the device 203, thereby allowing the device 203 to save the device context information. The device context information may be accessed by the host 201 post fatal condition occurrences and may be provided for post processing and/or interpretation to a device vendor. Consequently, ease of remote support to the end user of the device and/or Quality of Service (QOS) may be improved. In addition, device context availability may result in cost savings at original equipment manufacturers (OEMs) and/or device vendors.

The sequence of operations of the methods 410, 420, 510, and 520 may not be necessarily executed in the same order as they are presented. Further, one or more operations may be grouped together and performed in form of a single step, or one operation may have several sub-steps that may be performed in a parallel and/or in a sequential manner.

Furthermore, one or more computer-readable storage media may be utilized in implementing embodiments consistent with the present disclosure. A computer-readable storage medium may refer to any type of physical memory on which information and/or data that may be readable by a processor may be stored. Thus, a computer-readable storage medium may store instructions for execution by one or more processors, including instructions for causing the one or more processors to perform steps or stages consistent with the embodiments described herein. The term “computer-readable medium” may be understood to include tangible items and exclude carrier waves and transient signals, e.g., may be non-transitory. Examples may include, but may not be limited to, RAM, ROM, volatile memory, non-volatile memory, hard drives, compact disc (CD) ROMs (CD-ROMs), digital versatile drives (DVDs), flash drives, disks, other physical storage media, or the like.

It may be understood by those within the art that, in general, terms used herein, and are generally intended as “open” terms (e.g., the term “including” may be interpreted as “including but not limited to,” the term “having” may be interpreted as “having at least,” the term “includes” may be interpreted as “includes but is not limited to,” and the like). For example, as an aid to understanding, the detail description may contain usage of the introductory phrases “at least one” and “one or more” to introduce recitations. However, the use of such phrases may not be construed to imply that the introduction of a recitation by the indefinite articles “a” or “an” limits any particular part of description containing such introduced recitation to disclosure containing only one such recitation, even when the introductory phrases “one or more” or “at least one” and indefinite articles such as “a” or “an” (e.g., “a” and/or “an” may typically be interpreted to mean “at least one” or “one or more”) are included in the recitations; the same holds true for the use of definite articles used to introduce such recitations. In addition, even if a specific part of the introduced description recitation is explicitly recited, those skilled in the art will recognize that such recitation may typically be interpreted to mean at least the recited number (e.g., the bare recitation of “two recitations,” without other modifiers, typically means at least two recitations or two or more recitations).

While various aspects and embodiments have been disclosed herein, other aspects and embodiments may be apparent to those skilled in the art. The various aspects and embodiments disclosed herein are for purposes of illustration and are not intended to be limiting, with the scope and spirit being indicated by the foregoing detailed description.

1. A method for managing a failure condition at a host, the method comprising:
detecting an occurrence of a host critical failure event at the host;
configuring at least one panic bit of a host panic control register of a device, based on the detecting of the occurrence of the host critical failure event; and
issuing, to the device, at least one input/output (I/O) read/write command.

2. The method of claim 1, further comprising:
determining, during initialization of the device, a presence of a host panic capability register.

3. The method of claim 1, wherein the at least one panic bit indicates an event type of the host critical failure event.

4. The method of claim 1, wherein the host critical failure event comprises at least one of an improper driver event, a thrashing event, a corrupt registry event, a virus event, a Trojan Horse event, a slow system performance event, a failure to boot event, a compatibility error event, a power problem event, an overheating event, a motherboard failure event, a faulty random access memory (RAM) event, a faulty storage event, or a faulty processor event.

5. A method for managing a device internal context during a host failure condition at a device, the method comprising:
detecting a host critical failure event by monitoring status of a host panic control register;
receiving, from a host, at least one input/output (I/O) read/write command; and
storing, in a memory, device context information based on the at least one I/O read/write command.

6. The method of claim 5, further comprising:
initializing, during an initialization of the device, a host panic capability register to indicate that the device supports host panic situation awareness; and
receiving, through the host panic control register, information regarding occurrences of host critical failure events.

7. The method of claim 6, wherein the receiving of the information regarding the occurrences of the host critical failure events comprises:
reading at least one panic bit of the host panic control register that has been configured by the host.

8. : A method for managing a failure condition at a host, the method comprising:
detecting, in a device, a presence of a host panic capability register exhibiting support for host panic situation awareness;
preconfiguring a host panic control register of the device, wherein the preconfiguring comprises writing, in the host panic control register, a host panic table comprising addresses and corresponding data/value pairs, and wherein each entry of the host panic table indicates a host critical failure event; and
based on an occurrence of the host critical failure event, issuing, to the device, at least one input/output (I/O) read/write command.

9. The method as claimed in claim 8, wherein the detecting of the presence of the host panic capability register comprises:
determining, during an initialization of the device, the presence of the host panic capability register.

10. The method of claim 8, wherein the host critical failure event comprises at least one of an improper driver event, a thrashing event, a corrupt registry event, a virus event, a Trojan Horse event, a slow system performance event, a failure to boot event, a compatibility error event, a power problem event, an overheating event, a motherboard failure event, a faulty random access memory (RAM) event, a faulty storage event, or a faulty processor event.

11-24. (canceled)
